(19) United States
(12) Patent Application Publication
(10) Pub. No.: US 2013/0112288 A1
(43) Pub. Date: May 9, 2013

(54) SYSTEM AND METHOD PROVIDING A HEATER-ORIFICE AND HEATING ZONE CONTROLS FOR A VAPOR DEPOSITION SYSTEM

(71) Applicant: First Solar, Inc., Perrysburg, OH (US)

(72) Inventors: Litian Liu, Fremont, CA (US); Erel Milshtein, Cupertino, CA (US); Ulrich A. Bonne, Sunnyvale, CA (US); Valentin Gefter, San Jose, CA (US); Roger Malik, Warren, NJ (US); Raffi Garabedian, Los Altos, CA (US)

(73) Assignee: First Solar, Inc., Perrysburg, OH (US)

(21) Appl. No.: 13/667,479

(22) Filed: Nov. 2, 2012

Related U.S. Application Data
(60) Provisional application No. 61/555,921, filed on Nov. 4, 2011.

(51) Int. Cl. F16L 53/00

(52) U.S. Cl. 137/334

(57) ABSTRACT

A system and method employing a heater-orifice may be used to heat a flow path and to control the supply of vapor from a vaporizable material to an object. Variable or constant diameter heating rods may be used to apply heat to a flow path in order to control the supply of vapor from a vaporizable material. A baffle plate may be used to control the vapor pressure and vapor flow from a vessel containing a vaporizable material. The heater-orifice, heating rods, and baffle plate may be used alone or in combination with one another to control the flow of vaporizable material.

### CROSS REFERENCE TO RELATED APPLICATION

The present application claims priority to U.S. Provisional Patent Application No. 61/555,921, filed Nov. 4, 2011, the disclosure of which is incorporated by reference in its entirety.

### FIELD OF THE INVENTION

Embodiments of the invention relate to the manufacture of photovoltaic (PV) devices, and more particularly to a vapor deposition system for manufacturing PV devices and method of use.

### BACKGROUND OF THE INVENTION

A photovoltaic (PV) module, also known as a solar panel, is a device that converts the energy of sunlight directly into electricity by the photovoltaic effect. A PV module includes a plurality of photovoltaic cells, also known as solar cells, for example, crystalline silicon cells or thin-film cells. The photovoltaic cells convert light into electrical energy and are typically formed between front and back panels of the solar module. In thin-film modules, the photovoltaic cells can include sequential layers of various materials formed between a front panel and a back panel. As but one example, module layers can include a barrier layer, a transparent conducting oxide (TCO) layer, a buffer layer, and an active material layer, which includes semiconductor material layers and a back conductive layer, all of which can be deposited in sequence on a substrate or a superstrate which may be a glass, e.g., a soda lime glass. The active material layer, which is scribed to form photocells, is formed of one or more layers of semiconductor material such as amorphous silicon (a-Si), copper indium gallium diselenide (CIGS), cadmium telluride (CdTe), cadmium sulfide (CdS) or any other suitable light absorbing material.

One method of forming various layers of the photovoltaic cells is by vapor deposition. Examples of a vapor deposition system and method are shown in PCT Application PCT/US2009/066242 (Publication Number WO 2010/065535) and PCT/US2006/015645 (Publication Number WO 2006/116411), herein incorporated by reference in their entirety. In one conventional vapor deposition method, a heated vessel, such as a crucible, is provided containing a material that is to be vaporized. Upon being vaporized, vapor of the material then flows freely through a vapor feed stream toward a vapor supply orifice. The vapor supply orifice directs the material onto a substrate or superstrate, such as glass, which may have other material layers previously deposited thereon. The vaporized material will then condense on the substrate and form a solid film. The vapor supply orifice is heated indirectly, by either radiative heat or conduction, to provide control over the condensation rate of the deposited material. This arrangement provides some control over the temperature profile of the vapor deposition system; however, a greater control over the temperature profile of the vapor deposition system is desired.

### BRIEF DESCRIPTION OF THE DRAWINGS

FIG. 1 is an exploded perspective view of a disclosed embodiment of a vapor deposition system.

FIG. 2 is a perspective view of a disclosed embodiment of a vapor deposition system.

FIG. 2A is a top view of a first disclosed embodiment of a heating rod for a vapor deposition system.

FIG. 2B is a top view of a second disclosed embodiment of a heating rod for a vapor deposition system.

FIG. 3 is a cross-sectional view of a disclosed embodiment of a vapor deposition system.

FIG. 3A is a cross-section view of a second disclosed embodiment of a vapor deposition system.

FIG. 3B is a cross-section view of a third disclosed embodiment of a vapor deposition system.

FIG. 3C is a cross-section view of a fourth disclosed embodiment of a vapor deposition system.

FIG. 3D is a cross-section view of a fifth disclosed embodiment of a vapor deposition system.

FIG. 4 is a side view of a disclosed embodiment of a heat shield for a vapor deposition system.

FIG. 5A is a bottom perspective view of a first disclosed embodiment of a heater-orifice for a vapor deposition system.

FIG. 5B is a bottom perspective view of a second disclosed embodiment of a heater-orifice for a vapor deposition system.

FIG. 6A is a perspective view of a first disclosed embodiment of a baffle plate for a vapor deposition system.

FIG. 6B is a perspective view of a second disclosed embodiment of a baffle plate for a vapor deposition system.

FIG. 6C is a perspective view of a third disclosed embodiment of a baffle plate for a vapor deposition system.

FIG. 6D is a perspective view of a fourth disclosed embodiment of a baffle plate for a vapor deposition system.

FIG. 6E is a perspective view of a fifth disclosed embodiment of a baffle plate for a vapor deposition system.

FIG. 6F is a perspective view of a sixth disclosed embodiment of a baffle plate for a vapor deposition system.

FIG. 6G is a perspective view of a seventh disclosed embodiment of a baffle plate for a vapor deposition system.

FIG. 7A is a top view of a third disclosed embodiment of a heater-orifice for a vapor deposition system.

FIG. 7B is a top view of a fourth disclosed embodiment of a heater-orifice for a vapor deposition system.

FIG. 7C is a top view of a fifth disclosed embodiment of a heater-orifice for a vapor deposition system.

### DETAILED DESCRIPTION OF THE INVENTION

In the following detailed description, reference is made to the accompanying drawings, which form a part hereof and illustrate specific embodiments of the invention. These embodiments are described in sufficient detail to enable those skilled in the art to make and use them. It is to be understood that structural, logical, or procedural changes may be made to the specific embodiments disclosed without departing from the spirit and scope of the invention.

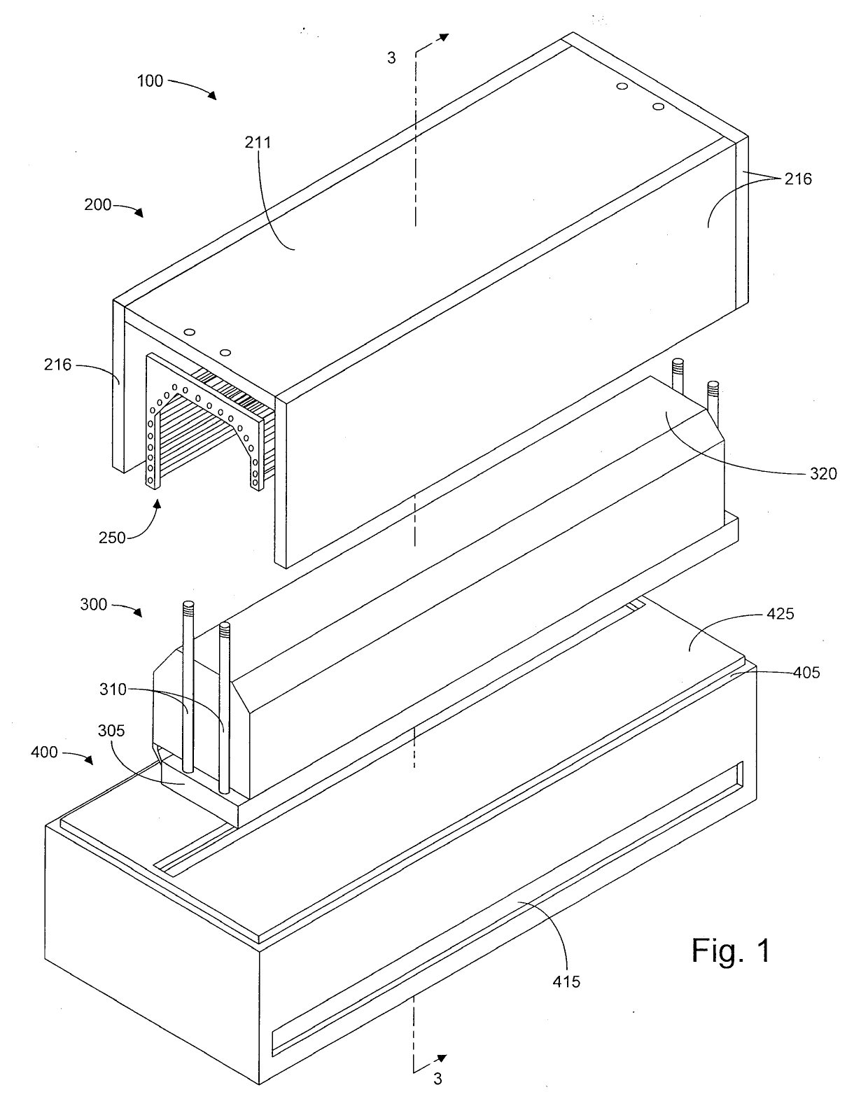

Embodiments disclosed herein provide better control over a temperature profile, the vapor pressure, and the material deposition rate of a vapor deposition system. FIG. 1 shows an exploded view of a vapor deposition system 100 in accordance with one embodiment. The vapor deposition system 100 is composed of a vessel assembly 300 and a housing assembly 200, which are suspended above a vapor deposition chamber 400. If desired, a heat shield 425 may be placed between the vessel assembly 300 and the vapor deposition chamber 400 to reduce heat lost by the vapor deposition system 100. The vapor deposition chamber 400 has an opening 415 to permit a module substrate (not shown) to be transported into the vapor deposition chamber 400 and a corresponding exit on the opposing side (not shown) from which to remove the substrate after the vaporized material has been deposited. The housing assembly 200 is composed of four side heat shields 216, a top heat shield 211, and a heating rod assembly 250. In FIG. 1, a side heat shield 216 on the end of the housing assembly 200 has been removed to show the heating rod assembly 250. In one embodiment, the vapor deposition system 100 and the deposition chamber 400 are housed in a vacuum chamber.

The vapor deposition system 100 described herein can be used to deposit any suitable material regardless of the fluid flow characteristics of the vapor material (e.g. velocity, pressure, density, viscosity, and temperature). As used herein, “vapor flow” and “vapor deposition” include materials with viscous flow characteristics (i.e. those materials with a relatively low Knudsen number, approximately less than 0.01), molecular flow characteristics (i.e. those with a relatively high Knudsen number, approximately greater than 1), or transitional flow characteristics (i.e. those with a Knudsen number approximately between 0.01 and 1).

As shown in FIG. 1, the side heat shields 216 and top heat shield 211 serve to protect the heating rod assembly 250 and vessel assembly 300 from damage and provides a framework within which the heating rod assembly 250 and vessel assembly 300 are contained. The side heat shields 216 and top heat shield 211 also prevent heat loss from the heating rod assembly 250 and serve to protect the surroundings from heat damage caused by excessive heat radiated from the heating rod assembly 250. The side heat shields 216 and top heat shield 211 include, in one embodiment, a high-temperature insulating material such as graphite felt, rigid carbon board, or alumina silica blankets. The heating rod assembly 250 is configured such that, when the vessel assembly 300 and the housing assembly 200 are assembled, the heating rod assembly 250 is placed onto and around an outer vapor deflector 320 of the vessel assembly 300.

The vessel assembly 300, which contains the material to be deposited, rests on a base 305 and is suspended by hangers 310 over the top plate 405 of a vapor deposition chamber 400. The hangers 310 are attached to each end of the base 305. By hanging the vessel assembly 300 only from the ends of the housing assembly 200, the heat lost by the vessel assembly 300 is reduced, and the temperature profile within the vessel assembly 300 can be controlled with greater precision.

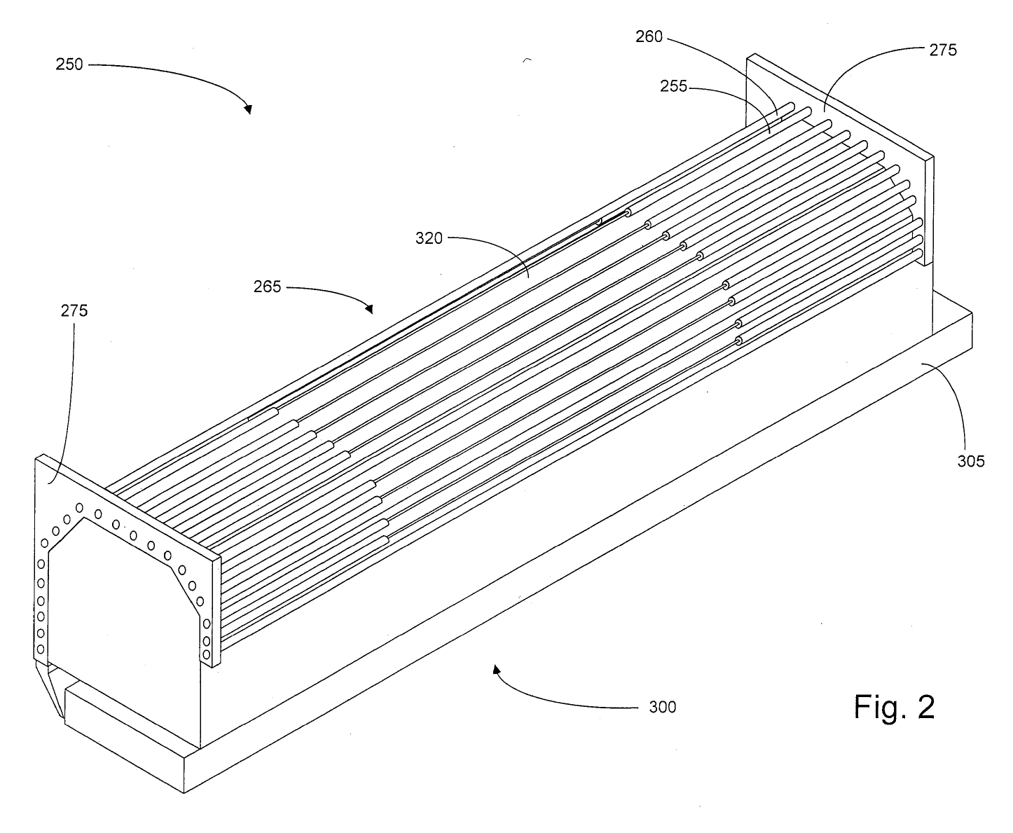

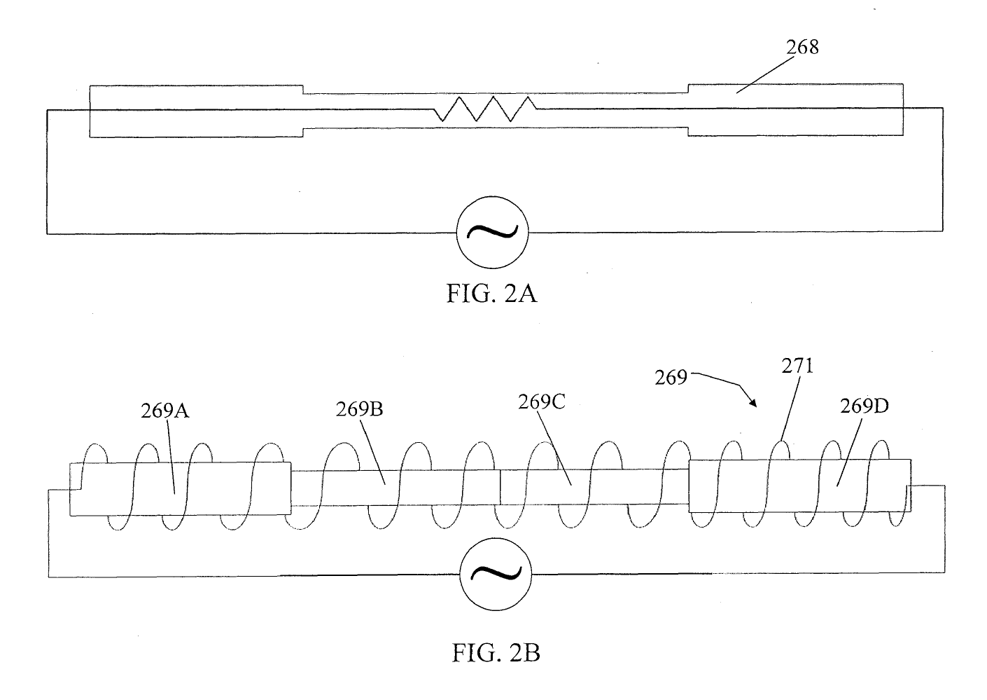

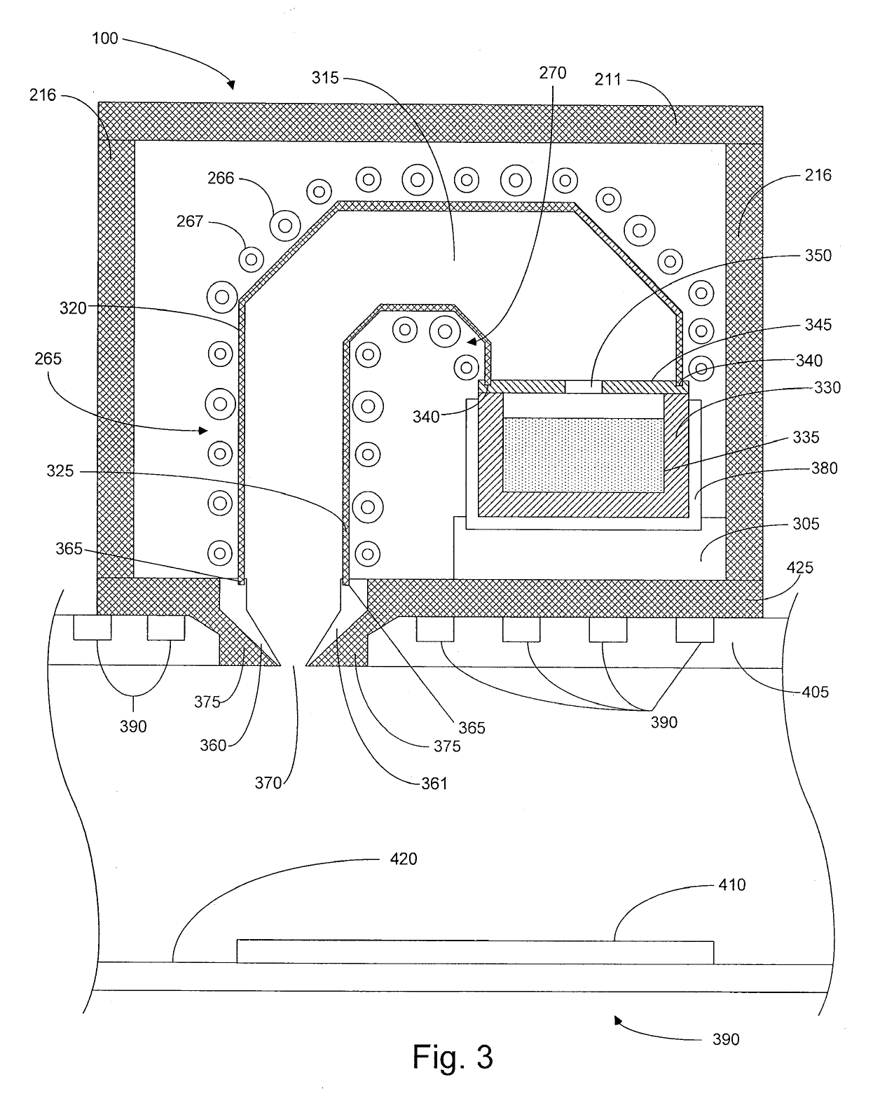

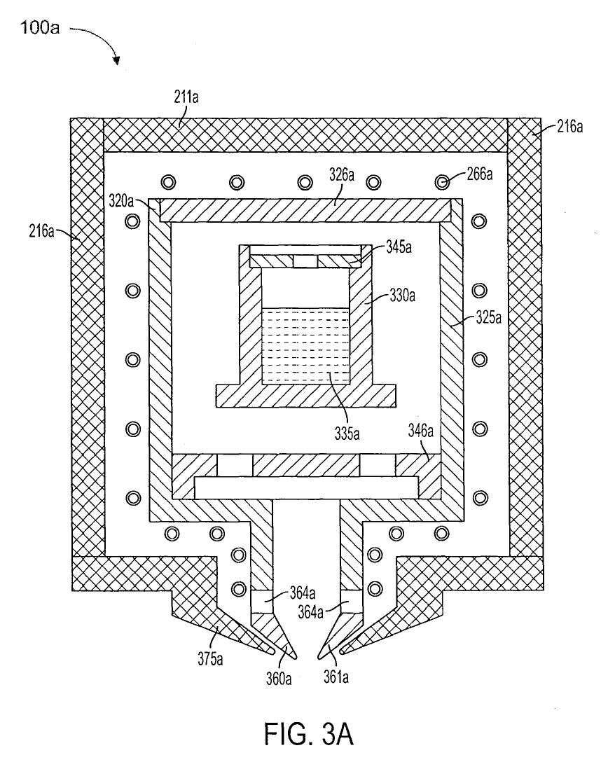

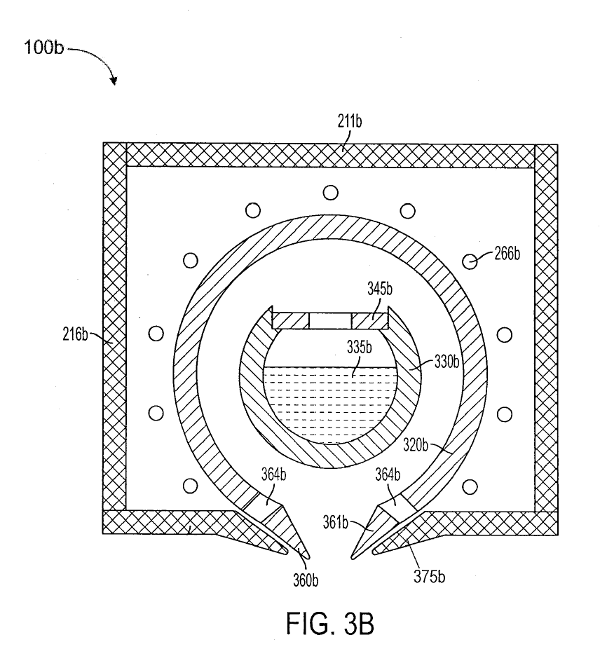

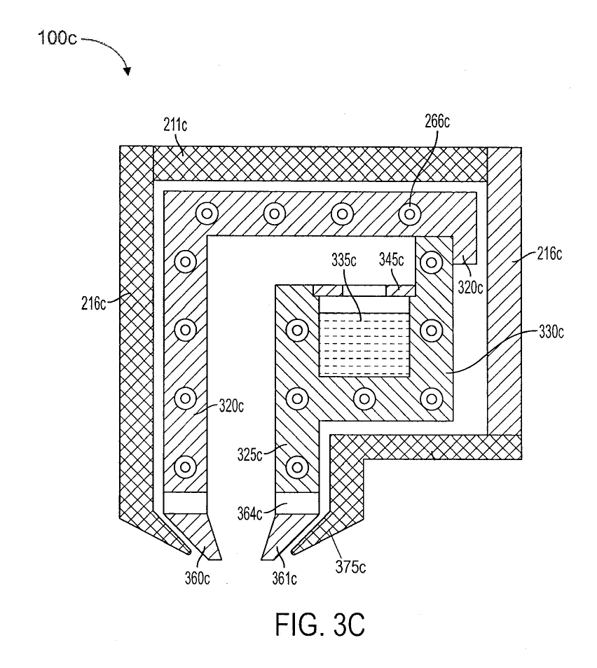

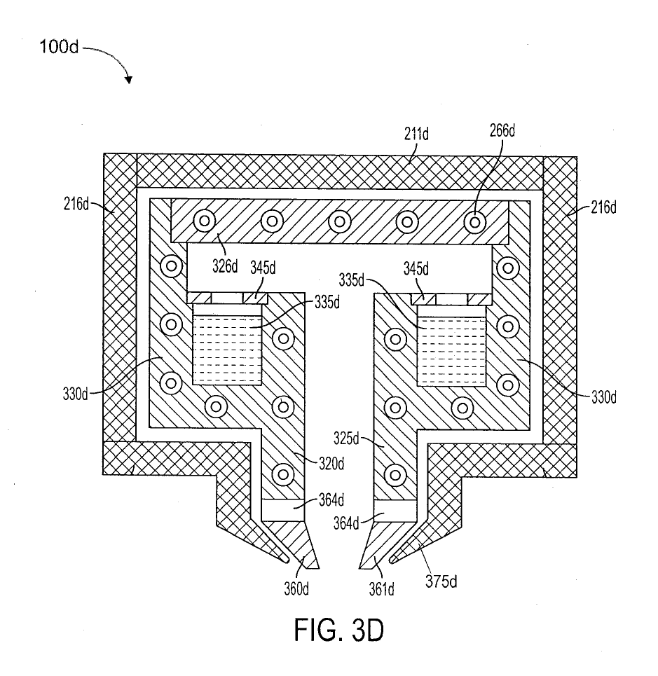

FIG. 2 shows a cut-away perspective view of the heating rod assembly 250 assembled in place on the vessel assembly 300. The heating rod set 265 may have varied diameter heating rods 255 or constant diameter heating rods 260. Heating rod brackets 275 hold the heating rods (e.g. 255, 260) of the heating rod set 265 in place. In addition, as better shown in FIG. 3, a cross section of the vapor deposition system 100, the diameters of the heating rods may change from one heating rod 266 of set 265 to a next heating rod 267 of set 265 in addition to a changing diameter along the length of a heating rod. In various embodiments, a heating rod assembly 250 may use only varied diameter heating rods 255, only constant diameter heating rods 260, or a combination of varied and constant diameter heating rods 255, 260.

In one embodiment, shown in FIG. 2A, an exemplary varied diameter resistive heating rod 268 may be heated by applying current to the ends of the heating rod, thus causing the heating rod to emit heat by resistive heating. In another embodiment, shown in FIG. 2B, an exemplary varied diameter heating rod 269 may be heated by wrapping an inductive heating coil 271 around the varied diameter heating rod 269 and applying current to the coil 271, thus causing the varied diameter heating rod 269 to be heated by inductive heating.

The varied diameter heating rod 268 may be machined from one continuous heating rod as shown in FIG. 2A. In another embodiment shown in FIG. 2B, the varied diameter heating rod 269 may be manufactured from several differing-diametered heating rod segments 269A, 269B, 269C, 269D, which are then connected end-to-end. To adjust the heating properties of the heating rod 269, the segments 269A, 269B, 269C, 269D may be manufactured from different materials with different resistive properties or other heating properties. This will result in different segments heating differently despite a constant inductive heating field (e.g. FIG. 2B) or electrical current (e.g. FIG. 2A) being applied to the segments. In another embodiment, a heating rod may instead have a constant diameter but be made of rod sections having the same or different resistances, and thus heating characteristics. In one embodiment, the segments 269A, 269B, 269C, 269D of the segmented heating rod 269 are adhered to one another with graphite glue or other heat resistant, conductive adhesives.

FIG. 3 shows a cross section along line 3-3 of FIG. 1 of the assembled vapor deposition system 100 on top plate 405 of the vapor deposition chamber 400. As noted, a heat shield 425 may also be provided beneath vapor deposition system 100 to reduce heat loss to the surroundings. The vapor deposition system 100 is composed of the several sub-assemblies discussed above, the components of each of which will be discussed in detail below.

As best shown in FIG. 3, the vapor deposition system 100 includes a vaporizable material vessel such as an elongated heated crucible 330, which can be loaded with a vaporizable material 335. In one embodiment, the elongated heated crucible 330 is offset from the centerline of the vapor deposition system 100. Once vaporized, the vaporizable material 335 forms a vapor stream, which flows out of the crucible 330 and through an elongated baffle plate 345. The baffle plate 345 is placed over the crucible 330 and is configured to constrict the vapor stream to provide control over the vapor pressure of the vaporizable material 335. Baffle plate 345 may have an elongated slit 350 therein running along the length of the crucible 330 through which vaporized material can flow into a redirector flow path 315. Both crucible 330 and slit 350 run the length of the vessel assembly 300.

A redirector flow path 315 is defined by outer and inner vapor deflectors 320, 325, configured to direct the vapor stream toward an elongated aperture 370, which also runs the length of the vessel assembly 300. At the vessel-side of the redirector flow path 315, the crucible 330 is provided with notches 340, into which the outer and inner vapor deflectors 320, 325 are inserted. The vapor deflectors 320, 325 then direct the vapor stream from the crucible 330, down one side of the offset crucible 330, and toward an elongated exit aperture 370. At the end of the redirector flow path 315, a heater-orifice composed of outer and inner heater-orifice elements 360, 361 defines the elongated exit aperture 370. At the aperture-side, the vapor deflectors 320, 325 terminate in notches 365 provided in heater-orifice elements 360, 361. This helps to seal the vapor deposition system 100 to provide greater temperature and pressure control. In one embodiment, the notches 340 and 365 are sealed with a sealant. The sealant may be any suitable heat resistant inert material such as a graphite foil.

At the end of the redirector flow path 315, the elongated exit aperture 370 directs the vapor stream onto a substrate 410 located below the vapor deposition system 100 in the vapor deposition chamber 400. The substrate 410 is continuously transported by a conveyor mechanism 420 through the vapor deposition chamber 400.

Along the redirector flow path 315, heating rod sets 265, 270 are placed on opposite sides of the redirector flow path 315 with heating rod set 265 placed along the outer vapor deflector 320 and heating rod set 270 placed along the inner vapor deflector 325. In one embodiment, the heating rod sets 265, 270 are sealed in a vacuum. The heating rod sets 265, 270 can be manufactured from graphite, a carbon composite, silicon carbide, an inert material coated with a conductive material such as refractory metals or other suitable conductive materials. The heating rod sets 265, 270 control the temperature profile along the redirector flow path 315 from the crucible 330 to the aperture 370. In addition, the heating rod sets 265, 270 may also provide heat to the crucible 330 to control the vaporization rate of the vaporizable material 335.

Depending on the desired operation, the heating rods of the heating rod sets 265, 270 may be electrically coupled in series, parallel, or a combination of series and parallel as desired to provide control over the temperature profile. In another embodiment, the heating rod sets 265, 270 are arranged into zones, such that, for example, the heating rods arranged around the crucible 330 are controlled independently from those further along the redirector flow path 315, which in turn are controlled independently from those proximate to the heater-orifice elements 360, 361 and the aperture 370. In another embodiment, each heating rod of the heating rod sets 265, 270 may be controlled independently.

The vaporizable material 335 is introduced into the crucible 330 by any suitable manner, including continuous or batch introduction. The vaporizable material 335 may be any suitable liquid or solid that vaporizes and is suitable for vapor deposition. This includes semiconductor materials such as copper indium gallium selenide (CIGS), cadmium telluride (CdTe), cadmium selenide (CdSe), or cadmium sulfide (CdS). The materials that may be deposited also include fluoride, sulfur, selenium, phosphorus, arsenic, tellurium, and all metals that normally evaporate as a vapor including copper, indium, sodium, magnesium, zinc, cadmium, and gallium.

The vaporizable material 335 is then vaporized by any suitable method. The vaporizable material 335 may be vaporized by electron beam evaporation using an electron gun, or the crucible 330 may be heated to cause vaporization by thermal evaporation. In one embodiment, a “U” shaped heater 380 may be formed around the crucible 330 in order to heat the vaporizable material 335. The vaporizable material 335 will then flow as a vapor stream from the crucible 330, through the elongated baffle plate 345 from which it is channeled by the outer and inner vapor deflectors 320, 325 to the exit aperture 370.

As noted, the outer and inner elongated heater-orifice elements 360, 361 define an aperture 370, which serves as the vapor stream's exit point from the redirector flow path 315. The heater-orifice elements 360, 361 may be formed of a resistive material and configured such that they directly heat the vapor stream as the vapor stream passes through the aperture 370. By directly heating the vapor stream, the resistive material heater-orifice elements 360, 361 provide greater control over the temperature profile at the exit aperture 370 of the vapor deposition system 100. By increasing or decreasing the current through the resistive heater-orifice elements 360, 361, an operator may control the heat supplied to the vapor stream as it exits the aperture 370.

If desired, the thickness of each heater-orifice elements 360, 361 may be greater at some points along the length of the heater-orifice elements 360, 361 than other points in order to modify the resistance of the heater-orifice elements 360, 361, thereby altering the heat emitted. In another embodiment, the heating rod sets 265, 270 also provide supplemental indirect heating to the heater-orifice elements 360, 361. The heater-orifice elements 360, 361 can be manufactured from graphite, a boron nitride coated graphite, a carbon composite, silicon carbide, an inert material coated with a conductive material such as refractory metals or other suitable conductive materials. In one embodiment, the heater-orifice elements 360, 361 are configured to be removable and replaceable to permit adjustment to the aperture 370. The different aperture configurations may be obtained by removing a first set of heater-orifice elements and installing a different set of heater-orifice elements with different aperture widths or configurations. As is shown in FIG. 3, the heater-orifice elements may be held in place by the vapor deflectors 320, 325 and the heat shield 375.

As is also shown in FIG. 3, the vapor stream exiting from the aperture 370 is deposited upon a substrate 410 that is located within the vapor deposition chamber 400, where the vapor stream condenses onto the substrate 410 to form a film. The substrate 410 may be any suitable material for use in photovoltaic devices including soda-lime glass, borosilicate glass, float glass, polycarbonate, other suitable polymers, carbon fiber, metallic plates, metallic foils, or ceramics. Water-cooled heat sinks 390 may be provided inset in the top plate 405 of the vapor deposition chamber 400. The water-cooled heat sinks 390 serve to reduce the heat transferred by the vapor deposition system 100 to the vapor deposition chamber 400.

A heat shield 375 may also be interposed between the heater-orifice elements 360, 361 and the substrate 410. The heat shield 375 serves to protect the substrate 410 from the heat emitted by the heater-orifice elements 360, 361. The heat shield 375 also serves to increase the efficiency of the vapor deposition system 100 by reducing the heat lost from the vapor deposition system 100. This will serve to decrease the energy used by and reduce the operational cost of the vapor deposition system 100. The heat shield 375 may be manufactured from any material suitable to reduce the heat emitted by the heater-orifice elements 360, 361 including alumina silica blankets, rigid carbon boards, graphite felt, or high temperature resistant metals such as molybdenum or molybdenum alloys.

FIGS. 3A, B, C, and D show cross-sections of simplified versions of the vapor deposition system 100 of FIG. 3 according to alternative embodiments. As is shown in FIG. 3A, the crucible 330a may be provided in the center of the vapor deposition system 100a. In this embodiment, the vapor deflectors 320a, 325a, 326a define a vapor flow path along each side of the crucible. As before, the vapor deflectors 320a, 325a, 326a are lined with heater rods (e.g. 266a) in order to control the temperature profile along the vapor flow path. A second baffle plate 346a may be provided along the vapor flow path at a midway point along the vapor deflectors 320a, 325a. In this embodiment, to protect the vapor deflectors 320a, 325a from the current applied to the heater-orifice elements 360a, 361a, electrical insulators 364a are inserted between the heater-orifice elements 360a, 361a and the vapor deflectors 320a, 325a. The electrical insulators 364a may be manufacture from any suitable material including hot-pressed boron nitride (HBN) or pyrolytic boron nitride (PBN).

As is shown in FIG. 3B, the crucible 330b may be formed as a “tube-within-a-tube.” In this configuration, one vapor deflector 320b is formed as a tube around the crucible 330b, defining a vapor path along each side of the crucible 330b. As is shown in FIG. 3C, the crucible 330c may be formed as an integral piece with a vapor deflector (e.g. 325c). In one embodiment, also shown in FIG. 3C, the heater rods (e.g. 266c) may be embedded within the crucible 330b or the vapor deflectors 320c, 325c. As is also shown in FIG. 3C, the side heat shield 216c may be configured to act as the heat shield for a heater-orifice element 360c. In another embodiment, shown in FIG. 3D, two crucibles 330d may be formed in the vapor deposition system 100d. Similar to the embodiment shown in FIG. 3C, each crucible 330d may be formed integral with the vapor deflectors 320d, 325d. In the embodiments shown in FIGS. 3A-3D, the heater rods (e.g. 266a-266d) may be configured in any of the forms described above including variable diameter or constant diameter heating rods. Adjacent heater rods may have the same or differing diameters depending on the desired temperature profile of the vapor deposition systems 100a-100d.

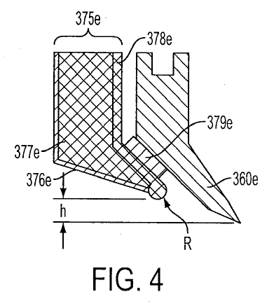

FIG. 4 shows an up-close side view of the heater-orifice element 360e and the heat shield 375e according to one embodiment. In this embodiment, the heat shield 375e is formed of three components: a core rigid board 377e laminated with a foil 376e and an inner wall 378e. The core rigid board 377e serves to insulate the inner wall 378e and heater-orifice element 360e and may be manufactured from rigid carbon board. The foil 376e and inner wall 378e are heated by the heater-orifice element 378e or the heater rods shown in FIGS. 3-3D to reduce accumulation of vaporizable material onto the heat shield 375e and may both be manufactured from hot-pressed boron nitride (HBN) or graphite among other suitable materials. In one embodiment, the three elements are bonded together using a suitable adhesive such as a graphite adhesive. An optional insulator 379e, for example hot-pressed boron nitride (HBN) or pyrolytic boron nitride (PBN), may be used to insulate the heat shield 375e from current provided to or heat emitted from the heater-orifice element 360e. In various embodiments, the inner wall 378e may be provided a rounded tip with a radius R and/or a vertical offset h between the lower end of the heater-orifice element 360e and the lower end of the heat shield 375e to reduce back-scattered vapor or condensation on the heat shield 375e.

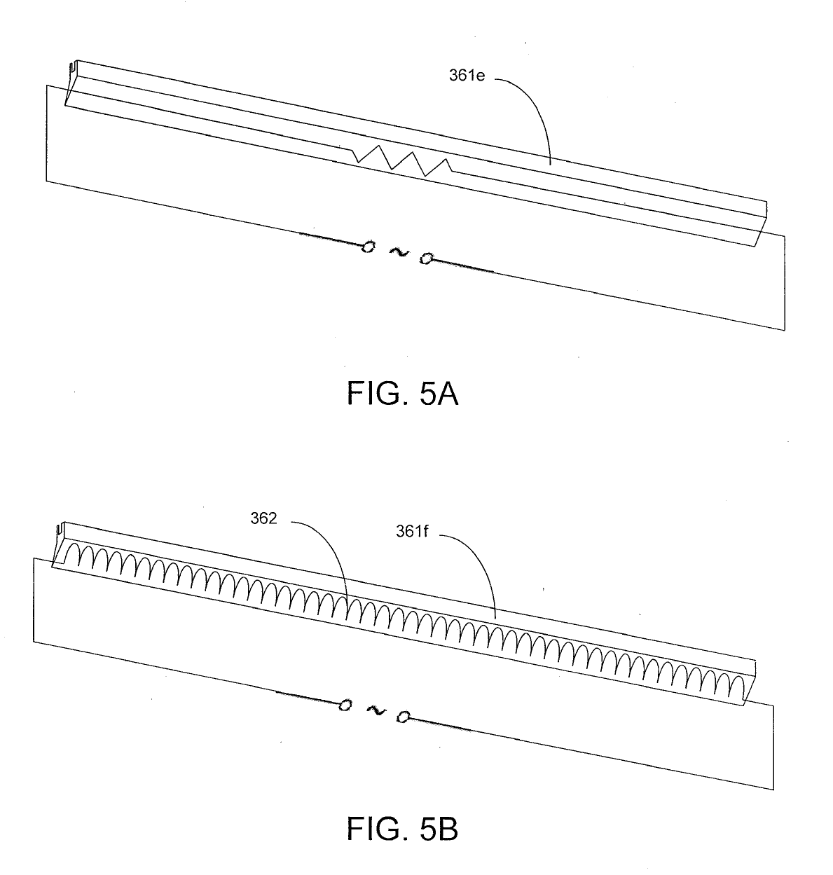

As is shown from a bottom perspective in FIGS. 5A and 5B, the heater-orifice elements, only 361e, 361f shown in FIGS. 5A and 5B, may be directly heated by resistive heating (FIG. 5A) or by inductive heating (FIG. 5B). If resistive heating is used, a current is applied at the ends of the heater-orifice element 361e as shown in FIG. 5A. If inductive heating is used, an inductive heating coil 362 is placed along the heater-orifice element 361f, between the heater-orifice element 361f and the heat shield 375, shown in FIG. 3. The inductive heating coil 362 applies a magnetic field to the heater-orifice element 361f to heat the heater-orifice element 361f by electromagnetic induction. By altering the current or magnetic field applied to the heater-orifice element 361e, 361f, the heat emitted by the heater-orifice element 361e, 361f may be increased or decreased.

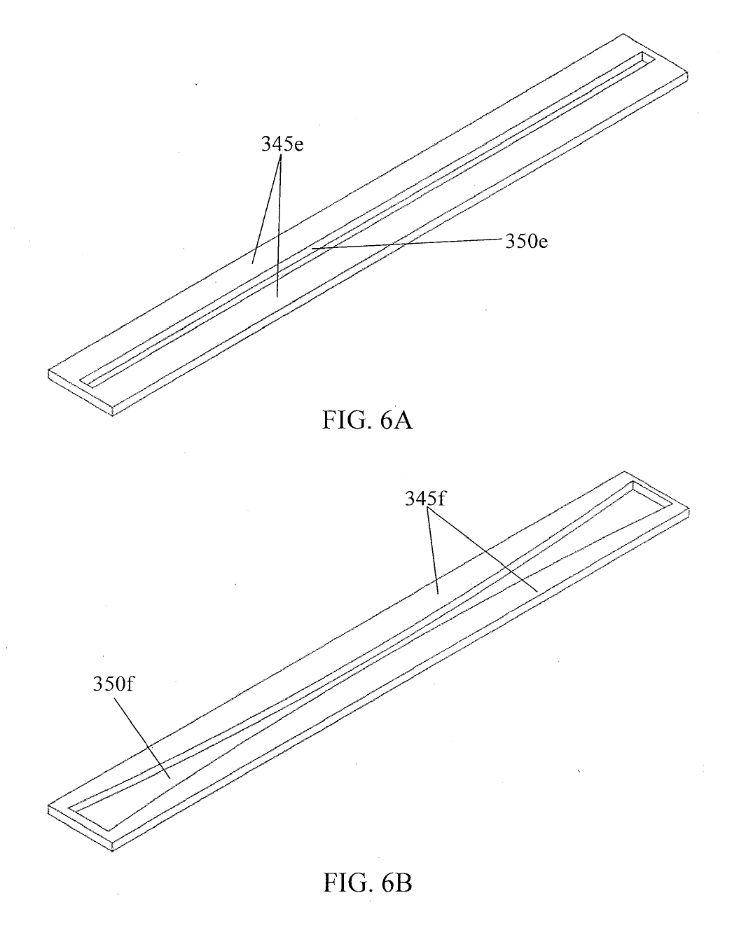

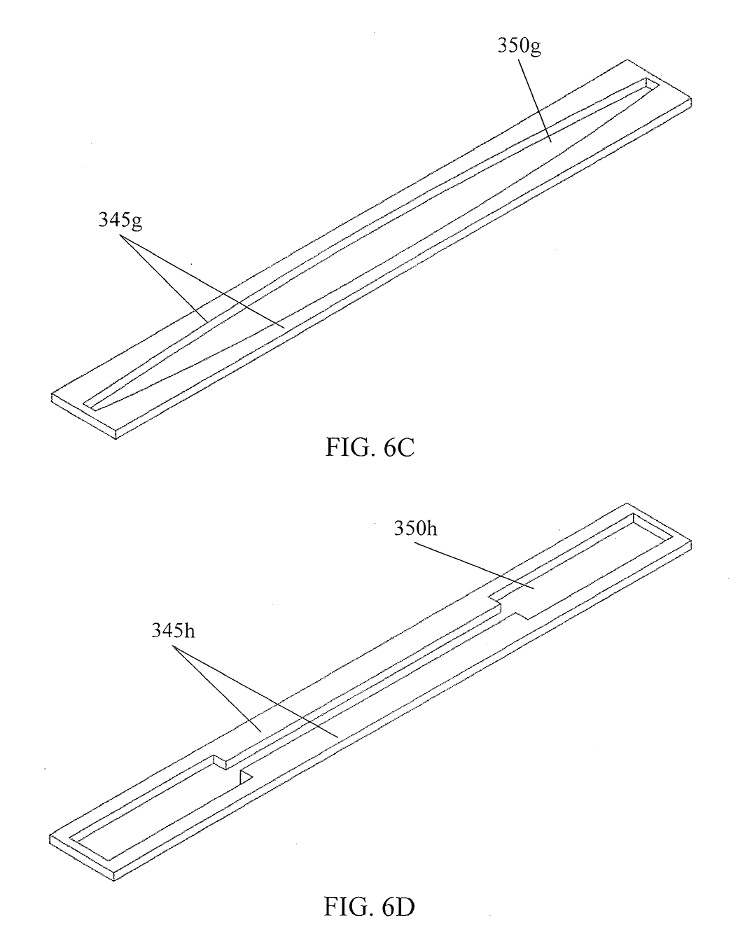

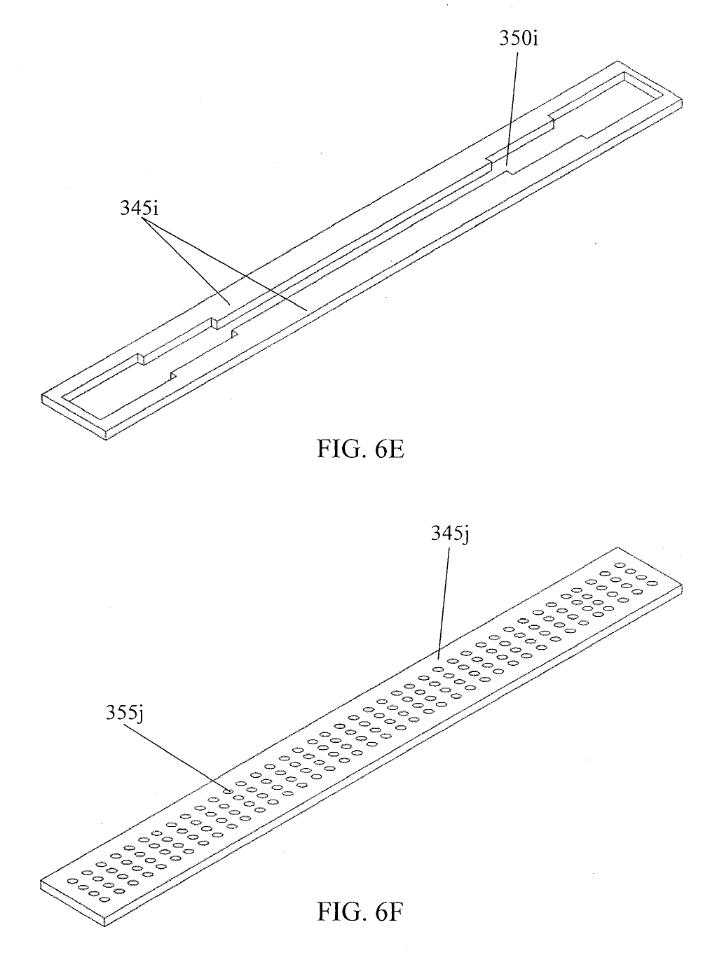

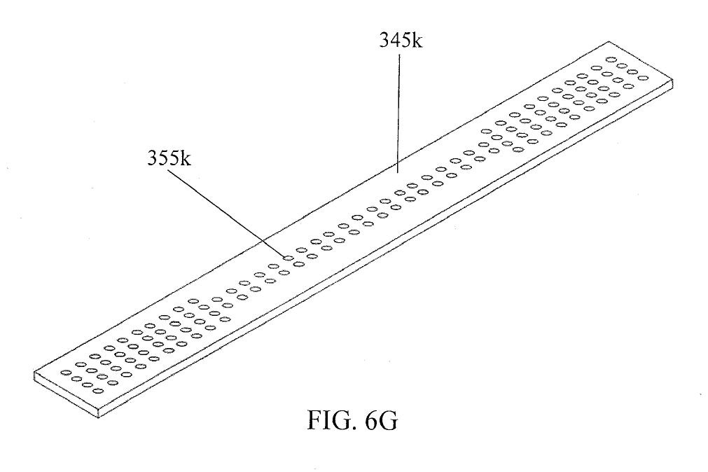

Several differently configured baffle plates 345e, 345f, 345g, 345h, 345i, 345j, 345k are shown in FIGS. 6A-G from a top perspective view. As shown, for example, in FIG. 6A, the baffle plate 345e has a slit opening 350 to permit transmission of the vaporized material as well as to control the vapor pressure of the vaporizable material 335. The baffle plate 345e serves to reduce the amount of spitting (liquid splatter from the crucible 330) which can spray down the redirector flow path 315. Spitting is undesirable because it could deposit upon the substrate 410, requiring reworking or scrapping the substrate 410. The baffle plates 345e, 345f, 345g, 345h, 345i, 345j, 345k may be manufactured from suitable, high-heat, non-reactive materials such as graphite, pyrolytic boron nitride (PBN), and refractory metals such as tungsten. Further, the baffle plate 345e, 345f, 345g, 345h, 345i, 345j, 345k may have different configurations to allow for a tailoring of the vapor pressure.

In the embodiment shown in FIG. 6A, the slit opening 350e has a uniform width along the length of the baffle plate 345e to control the vapor pressure of the vaporizable material 335. In another embodiment shown in FIG. 6B, the baffle plate 345f has a slit opening 350f that tapers such that it narrows toward the center of the baffle plate 345f from the ends to promote a uniform deposition onto the substrate 410 along the length of the vapor deposition system 100. In one embodiment, the width of the slit opening 350f increases at a geometric rate from the center of the baffle plate 345f to its ends. Tapering the slit opening 350f provides the advantage of allowing for a higher vapor flux at the ends than towards the center of the assembly. This arrangement may be used to adjust for heat lost from the ends of the vapor deposition system 100. In another embodiment shown in FIG. 6C, the baffle plate 345g may have a slit opening 350g that is wider in the center than at the ends if a higher flux rate or deposition rate is desired in the center of the vapor deposition system 100 than at the ends or if the temperature is lower in the center. FIGS. 6D and 5E show two other embodiments of a baffle plate 345h, 345i. In these embodiments, the width of the slit opening 350h, 350i is stepped rather than continuously widened.

FIGS. 6F and 6G show two other embodiments of the baffle plate 345j, 345k. In these embodiments, the baffle plate 345j, 345k has perforations 355j, 355k. The width of the perforated area of the baffle plate 345j, 345k may vary along the length as shown in FIG. 6G or may be constant as shown in FIG. 6F. In one embodiment, the baffle plate (e.g. 345e) may be removed and replaced with an alternately configured baffle plate (e.g. 3450 to allow an operator to tailor the vapor pressure profile and vapor flux of the vapor deposition system 100.

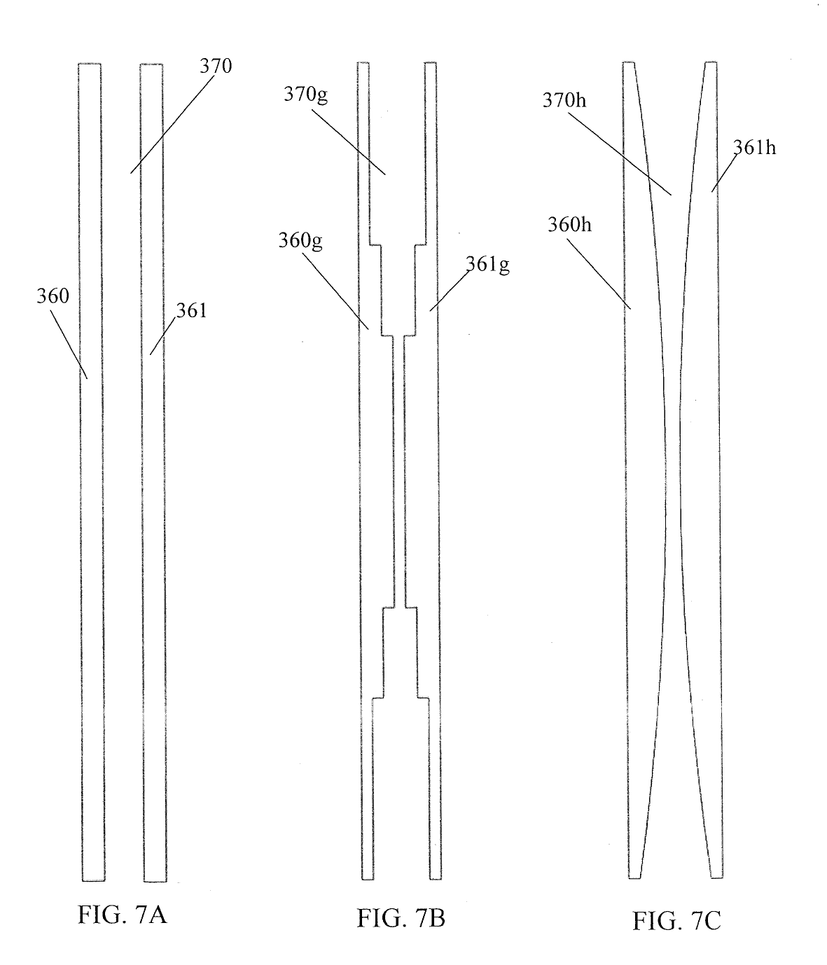

Similar to the slit openings 350e, 350f, 350g, 350h, 350i shown in FIGS. 6A-E, the configuration and material thickness of the heater-orifice elements 360, 361 may be adjusted along the length of the vapor deposition system 100, as shown in the top perspective views of FIGS. 7A-C, to taper the aperture 370, 370g, 360h, which modifies the vapor flux and the material deposition rate. Thus, the aperture 370 may have a constant width along the length of the vapor deposition system 100 (FIG. 7A); the aperture 370g may have a stepped pattern (FIG. 7B); or the aperture 370h may continuously taper to be wider at the ends than at the center (FIG. 7C). By modifying the material thickness of the heater-orifice elements 360g, 361g, 360h, 361h as shown, the aperture 370g, 370h may be constricted to modify the deposition rate onto the substrate 410.

The baffle plate 345, varied diameter heating rods 255, constant diameter heating rods 260, and heater-orifice elements 360, 361 of the various embodiments discussed above may be combined as desired. By matching the design parameters of the embodiments discussed above with the desired performance of the vapor deposition system 100, a user may exert greater control over the vapor pressure of the crucible 330, temperature profile of the crucible 330, temperature profile along the redirector flow path 315, temperature profile at the exit aperture 370, and material deposition rate onto the substrate 410.

While various embodiments have been described herein, various modifications and changes can be made. Accordingly, the disclosed embodiments are not to be considered as limiting as the invention is defined solely by the scope of the appended claims.

1. A vapor deposition system comprising:
a vessel for holding a vaporizable material;
a flow path for directing a vapor stream from said vessel; and
a heater-orifice for receiving the vapor stream from said flow path and for providing a vapor stream outlet, said heater-orifice configured to emit heat, which heats the vapor stream as it passes through said heater-orifice.

2. (canceled)

3. The system of claim 1, further comprising a heat shield provided adjacent the heater-orifice to reduce the heat loss from the heater-orifice.

4. The system of claim 3, further comprising an insulator configured to insulate the heat shield from the heater-orifice.

5. The system of claim 3, further comprising an offset between the heater-orifice and the heat shield.

6. The system of claim 3, wherein the heat shield comprises a rounded tip.

7-11. (canceled)

12. The system of claim 1, further comprising:
a second vessel for holding a vaporizable material; and
a second flow path for directing a second vapor stream from said second vessel;
wherein said second flow path and said flow path join before being received by said heater-orifice.

13. The system of claim 12, further comprising a first vapor deflector, a second vapor deflector, and a third vapor deflector, wherein the first vapor deflector and third vapor deflector cooperate to define said flow path, the second vapor deflector and third vapor deflector cooperate to define said second flow path, and the first and second vapor deflectors cooperate to define the joined flow path.

14. The system of claim 13, wherein the vessel is integral with the first vapor deflector and the second vessel is integral with the second vapor deflector.

15-19. (canceled)

20. The system of claim 1, wherein the heater-orifice is formed of a resistive material, said system further comprising an electrical source for passing electrical current through said heater-orifice.

21. The system of claim 1, wherein the heater-orifice is formed of an inductive material, said system further comprising an inductive heater for heating said heater-orifice.

22-32. (canceled)

33. The system of claim 1, wherein the heater-orifice is removable from the vapor deposition system.

34. (canceled)

35. The system of claim 1, further comprising an elongated aperture in the heater-orifice that comprises a width, wherein the width is constant along the length of the aperture.

36. The system of claim 1, further comprising an elongated aperture in the heater-orifice that comprises a width, wherein the width at a first point along the elongated aperture is greater than the width at a second point along the elongated aperture.

37. The system of claim 36, wherein the width increases continuously from the width at the second point to the width at the first point.

38. The system of claim 1, further comprising an elongated aperture in the heater-orifice that comprises a first width at a first segment along the elongated aperture and a second width at a second segment along the elongated aperture, wherein the first width is greater than the second width to form a stepped pattern.

39. The system of claim 38, wherein the elongated aperture further comprises a third width at a third segment along the elongated aperture, wherein the third width is greater than the first and second widths.

40-48. (canceled)

49. A vapor deposition system comprising:
a vessel for holding a vaporizable material;
a flow path for directing a vapor stream from said vessel;
an aperture configured to direct the vapor stream from said flow path onto a substrate; and
a baffle plate covering a portion of a longitudinal extent of the vessel, wherein the baffle plate is configured to vary a vapor pressure of the vaporizable material along the longitudinal extent of said vessel.

50. The system of claim 49, wherein the baffle plate comprises a slit opening which extends longitudinally along the longitudinal extent of the vessel.

51. The system of claim 50, wherein the slit opening comprises a width, wherein the width of the slit opening increases continuously from a center of the longitudinal extent of the vessel to an end of the longitudinal extent of the vessel.

52. The system of claim 50, wherein the slit opening comprises a first width at a first point along the slit opening and a second width at a second point along the slit opening, wherein the first width is greater than the second width.

53. The system of claim 50, wherein the slit opening comprises a stepped opening such that the slit opening has a first width along a first portion of the slit opening and a second width along a second portion of the slit opening, wherein the first width is greater than the second width.

54. The system of claim 53, wherein the slit opening further comprises a third width along a third portion of the slit opening, wherein the third width is greater than both the first and second widths.

55. The system of claim 49, wherein the baffle plate comprises a perforated area, wherein the perforated area comprises a plurality of perforations.

56. The system of claim 55, wherein the perforate area comprises a width along the longitudinal extent of the vessel, wherein the width is at a first portion of the baffle plate is greater than the width at a second portion of the baffle plate.

57. The system of claim 49, further comprising a second baffle plate located along the flow path between the vessel and the heater-orifice.

58. The system of claim 57, wherein the second baffle plate comprises at least one slit opening which extends longitudinally along the longitudinal extent of the vessel.

59. A vapor deposition system comprising:
a vessel for holding a vaporizable material;
a flow path for directing a vapor stream from said vessel;
an aperture configured to direct the vapor stream from said flow path onto a substrate; and
a plurality of spaced heating rods for heating the flow path, wherein at least one heating rod comprises a first diameter at a first portion of its length and a second diameter at a second portion of its length, wherein the first diameter is greater than the second diameter.

60. The system of claim 59, wherein at least one of the plurality of heating rods is embedded into the vessel.

61. The system of claim 59, further comprising at least one vapor deflector that defines the flow path.

62. The system of claim 61, wherein at least one of the plurality of heating rods is embedded into the at least one vapor deflector.

63. The system of claim 59, wherein at least one heating rod is formed of a resistive material, said system further comprising an electrical source for passing electrical current through said heating rod.

64. The system of claim 59, wherein at least one heating rod is formed of an inductive material, said system further comprising an inductive heater for heating said at least one heating rod.

65. The system of claim 63, wherein said electrical source is capable of passing electrical current through the first heating rod formed of resistive material and a second heating rod formed of resistive material, further wherein said electrical source is capable of passing electrical current through the first heating rod independently from the second heating rod.

66. The system of claim 59, wherein at least some of the plurality of spaced heating rods are electrically connected in parallel.

67. The system of claim 59, wherein at least some of the plurality of spaced heating rods are electrically connected in series.

68. The system of claim 59, wherein at least one heating rod comprises at least two segments combined to form the at least one heating rod.

69. The system of claim 59, wherein at least one heating rod comprises a unitary element.

70. The system of claim 59, wherein at least a second heating rod comprises a longitudinal extent and a diameter, wherein said diameter is substantially constant along the longitudinal extent of the second heating rod.

71. The system of claim 70, wherein said diameter of the second heating rod is not equal to either the first diameter or the second diameter of the first heating rod.

72. The system of claim 59, wherein at least a second heating rod comprises a third diameter and a fourth diameter, wherein the third diameter is not equal to the first diameter or the second diameter and is greater than the fourth diameter.

73-80. (canceled)
